(19) United States
(12) Patent Application Publication
(10) Pub. No.: US 2025/0328158 A1
(43) Pub. Date: Oct. 23, 2025

(54) REFERENCE VOLTAGE GENERATION CIRCUIT

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Kunihiko NAKAMURA, Nisshin-shi (JP); Masaya KONDO, Nisshin-shi (JP); Yoshikazu FURUTA, Nisshin-shi (JP); Tomohiro NEZUKA, Nisshin-shi (JP); Yukihiro TOMONAGA, Kariya-city (JP); Kazutaka HONDA, Kariya-city (JP)

(21) Appl. No.: 19/060,288

(22) Filed: Feb. 21, 2025

(30) Foreign Application Priority Data
Apr. 23, 2024 (JP) 2024-069809

(51) Int. Cl. G05F 3/18

(52) U.S. Cl. CPC G05F 3/18

(57) ABSTRACT

A reference voltage generation circuit for outputting a reference voltage includes: a constant current source; a constant voltage generation circuit having a Zener diode for generating a constant voltage based on a Zener voltage; a current generation circuit for generating a PTAT current having a positive temperature characteristic with respect to absolute temperature without an operational amplifier; and a temperature characteristic adjustment circuit including a temperature characteristic adjustment resistor. A voltage acquired by subtracting a voltage drop in the temperature characteristic adjustment circuit when the PTAT current flows from the constant voltage is output as the reference voltage.

### CROSS REFERENCE TO RELATED APPLICATION

The present application claims the benefit of priority from Japanese Patent Application No. 2024-069809 filed on Apr. 23, 2024. The entire disclosure of the above application is incorporated herein by reference.

### TECHNICAL FIELD

The present disclosure relates to a reference voltage generation circuit.

### BACKGROUND

To perform highly accurate voltage measurement, a highly accurate reference voltage generation circuit is required to be used as the reference voltage for the A/D converter. However, there is a difficulty in that the accuracy may deteriorate due to the stress applied to the reference voltage generation circuit.

For this reason, in the reference voltage generation circuit according to a conceivable technique, a reference voltage is generated based on a current Iptat (i.e., proportional to absolute temperature, hereinafter referred to as PTAT current) having a positive temperature characteristic proportional to absolute temperature and a Zener diode, thereby reducing an error in the reference voltage due to the stress. Specifically, the PTAT current Iptat is generated, and a voltage generated based on the PTAT current Iptat is subtracted from the voltage generated by the Zener diode, thereby canceling the temperature characteristic of the voltage generated by the Zener diode.

### SUMMARY

According to an example, a reference voltage generation circuit for outputting a reference voltage may include: a constant current source; a constant voltage generation circuit having a Zener diode for generating a constant voltage based on a Zener voltage; a current generation circuit for generating a PTAT current having a positive temperature characteristic with respect to absolute temperature without an operational amplifier; and a temperature characteristic adjustment circuit including a temperature characteristic adjustment resistor. A voltage acquired by subtracting a voltage drop in the temperature characteristic adjustment circuit when the PTAT current flows from the constant voltage is output as the reference voltage.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a circuit diagram of a reference voltage generation circuit according to a first embodiment of the present disclosure;

FIG. 2 is a diagram showing a specific circuit configuration of the reference voltage generation circuit shown in FIG. 1;

FIG. 3 is a circuit diagram of a reference voltage generation circuit according to a second embodiment of the present disclosure;

FIG. 4 is a circuit diagram of a reference voltage generation circuit according to a modified example of the second embodiment;

FIG. 5 is a circuit diagram of a reference voltage generation circuit according to a third embodiment of the present disclosure;

FIG. 6 is a diagram showing an example of a circuit configuration of a trimming resistor;

FIG. 7 is a circuit diagram of a reference voltage generation circuit according to a fourth embodiment of the present disclosure; and

FIG. 8 is a circuit diagram of a reference voltage generation circuit according to a fifth embodiment of the present disclosure.

### DETAILED DESCRIPTION

However, in the conceivable technique, since the PTAT current Iptat is generated by a Brokaw cell circuit, an operational amplifier or the like is required, and the number of elements used in the circuit configuration increases. Thus, there is a difficulty in that the accuracy of the reference voltage generated by the reference voltage generation circuit may decrease due to variations between elements and noise generated during circuit operation.

An object of the present embodiments is to provide a reference voltage generation circuit that is capable of improving the accuracy of a reference voltage without including an operational amplifier.

According to one aspect of the present embodiments, a reference voltage generation circuit for outputting a reference voltage (i.e., VREF) includes: a constant current source that generates a constant current; a constant voltage generation circuit having a Zener diode to which a current is supplied from the constant current source, and generating a constant voltage based on a Zener voltage formed by the Zener diode; a current generation circuit that generates a PTAT current having a positive temperature characteristic with respect to absolute temperature based on the constant voltage without including an operational amplifier; and a temperature characteristic adjustment circuit including a temperature characteristic adjustment resistor through which the PTAT current generated by the current generation circuit flows. A voltage acquired by subtracting a voltage drop in the temperature characteristic adjustment circuit when the PTAT current flows from the constant voltage is output as the reference voltage.

In the reference voltage generation circuit configured in this manner, the PTAT current has a positive temperature characteristic. In addition, the constant voltage generated by the Zener voltage also has a positive temperature characteristic based on the characteristics of the Zener diode. The reference voltage is a value obtained by subtracting the voltage drop at the temperature characteristic adjustment resistor, which also has a positive temperature characteristic, from a constant voltage based on a Zener voltage, which has a positive temperature characteristic. Therefore, the temperature characteristic of the reference voltage can be reduced, and by adjusting the resistance value of the temperature characteristic adjustment resistor, it is possible to make the temperature characteristic of the reference voltage to be even flat.

Therefore, the temperature characteristic of the reference voltage can be reduced without requiring an operational amplifier that has a large number of elements. Therefore, the influence of variations between elements can be reduced, and noise generated from the elements during circuit operation can be reduced, so that it is possible to improve the accuracy of the reference voltage.

A reference numeral in parentheses attached to each component or the like indicates an example of correspondence between the component or the like and specific component or the like described in an embodiments below.

Embodiments of the present disclosure will be described below with reference to the drawings. In the following embodiments including other embodiments to be described below, the same or equivalent components will be described with the same reference numerals.

### First Embodiment

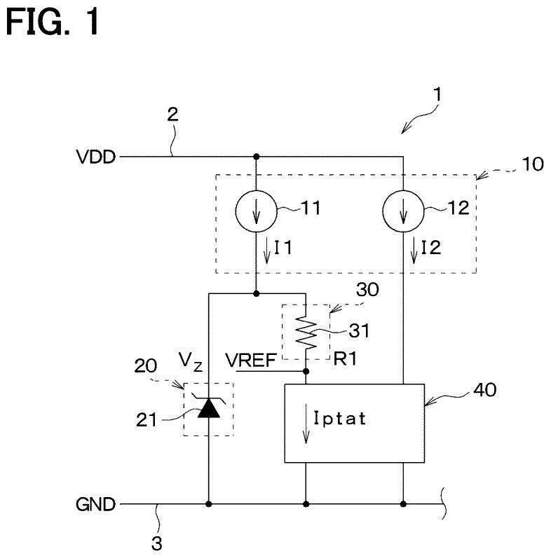

A first embodiment of the present disclosure will be described. First, the basic circuit configuration of a reference voltage generation circuit according to the present embodiment will be described with reference to FIG. 1.

The reference voltage generation circuit 1 shown in FIG. 1 is a circuit that generates a predetermined reference voltage VREF based on a power supply voltage VDD applied through a power supply line 2. The power supply voltage VDD may be any voltage that can be used to generate the reference voltage VREF, that is, any voltage greater than the reference voltage VREF, and may be, for example, a voltage greater than 5 V generated by a 5V power supply, which is a general constant voltage source. Here, the power supply voltage VDD is assumed to be about 9 to 14 V.

The reference voltage generation circuit 1 includes a constant current source 10, a constant voltage generation circuit 20, a temperature characteristic adjustment circuit 30, and an Iptat generation circuit 40.

In this embodiment, the constant current source 10 includes a first constant current source 11 and a second constant current source 12, and generates a constant current based on the power supply voltage VDD from the power supply line 2. The first constant current source 11 generates a first constant current I1 for supplying current to the constant voltage generation circuit 20, the temperature characteristic adjustment circuit 30, and the Iptat generation circuit 40. The second constant current source 12 generates a second constant current I2 for supplying a current to the Iptat generation circuit 40. The current values of the first constant current I1 and the second constant current I2 may be the same, alternatively, in the present embodiment, the first constant current I1 is set to a relatively large current value, and the second constant current I2 is set to a smaller current value than the first constant current I1. For example, the first constant current I1 is set to about 100 to 200 μA, and the second constant current I2 is set to about 10 μA, which is about 1/10 of the first constant current I1.

The constant voltage generation circuit 20 is a circuit that generates a constant voltage to be applied to the temperature characteristic adjustment circuit 30 and the Iptat generation circuit 40. In this embodiment, the constant voltage generation circuit 20 includes only a Zener diode 21, and the Zener voltage Vz generated by the Zener diode 21 is used as the constant voltage. Specifically, the first constant current source 11 and the Zener diode 21 are connected in series between a power supply line 2 and a GND (i.e., ground) line 3, and the cathode of the Zener diode 21 is connected to the first constant current source 11, and the anode of the Zener diode 21 is connected to the GND (i.e., ground) line 3. Therefore, the constant voltage generation circuit 20 generates the breakdown voltage of the Zener diode 21, that is, the Zener voltage Vz, as a constant voltage for the connection point between the Zener diode 21 and the first constant current source 11. The constant voltage is set to a voltage higher than the reference voltage VREF, for example, about 6 to 7 V.

The temperature characteristic adjustment circuit 30 generates a reference voltage VREF together with the Iptat generation circuit 40 based on the flow of the PTAT current Iptat generated by the Iptat generation circuit 40. Here, the temperature characteristic adjustment circuit 30 is configured by a temperature characteristic adjustment resistor 31, one end of the temperature characteristic adjustment resistor 31 is connected to the cathode of the Zener diode 21, and the other end is connected to the Iptat generation circuit 40.

The Iptat generation circuit 40 corresponds to a current generation circuit, and generates the reference voltage VREF by generating the PTAT current Iptat, which is a current having a positive temperature characteristic proportional to the absolute temperature, without using an operational amplifier. Specifically, the Iptat generation circuit 40 generates the PTAT current Iptat based on the first constant current I1 and the second constant current I2, thereby generating the reference voltage VREF as the potential between the temperature characteristic adjustment circuit 30 and the Iptat generation circuit 40. The reference voltage VREF is a value obtained by subtracting the voltage drop of the temperature characteristic adjustment circuit 30 from the constant voltage generated by the constant voltage generation circuit 20. Therefore, the temperature characteristic of the constant voltage generation circuit 20 is cancelled based on the temperature characteristic of the temperature characteristic adjustment circuit 30, and the temperature characteristic can be made flat.

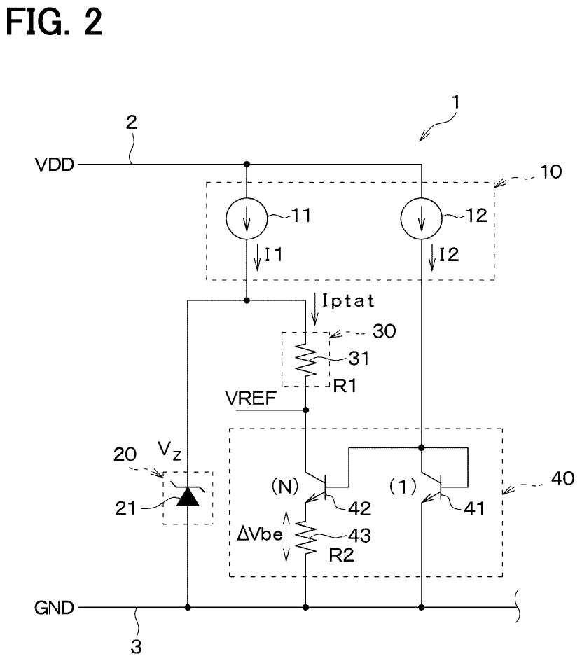

FIG. 2 shows an example in which the Iptat generation circuit 40 has a Widlar type circuit configuration, and the reason why the temperature characteristic of the reference voltage VREF becomes flat will be described along with the operation of the reference voltage generation circuit according to this embodiment.

As shown in FIG. 2, in this embodiment, the Iptat generation circuit 40 is configured by a first transistor 41, a second transistor 42, and an Iptat generation resistor 43. The first transistor 41 and the second transistor 42 form a pair of transistors. Of these, the first transistor 41 corresponds to one transistor, and the second transistor 42 corresponds to the other transistor.

The first transistor 41 and the second transistor 42 are configured by NPN-type bipolar transistors. The current density is made different by, for example, making the element area of the second transistor 42 different from that of the first transistor 41, and the element area of the second transistor 42 is designed to be N times (where N is a positive value) that of the first transistor 41. Specifically, the first transistor 41 and the second transistor 42 have their bases commonly connected to the second constant current source 12. The collector of the first transistor 41 is connected to the second constant current source 12, and the collector of the second transistor 42 is connected to the temperature characteristic adjustment circuit 30. The emitter of the first transistor 41 is connected to the GND line 3, and the emitter of the second transistor 42 is connected to the GND line 3 via an Iptat generation resistor 43. By connecting the Iptat generation resistor 43 between the emitter of the second transistor 42 and the GND line 3, a voltage difference ΔVbe corresponding to the voltage drop is generated between both ends of the Iptat generation resistor 43.

The reference voltage generation circuit 1 having such a circuit configuration operates as follows.

First, a constant voltage is generated in the constant voltage generation circuit 20 based on the current supplied from the first constant current source 11. In this embodiment, the constant voltage is the Zener voltage Vz. Furthermore, the first transistor 41 and the second transistor 42 are driven based on the current supply from the second constant current source 12, and a current flows between the collectors and the emitters of the first transistor 41 and the second transistor 42, respectively. The current flowing between the collector and emitter of the second transistor 42 is the PTAT current Iptat that also flows through the temperature characteristic adjustment circuit 30 and the Iptat generation resistor 43. The difference in the current density between the first transistor 41 and the second transistor 42 causes a voltage difference ΔVbe to occur between both ends of the Iptat generation resistor 43, and the PTAT current Iptat flows through the Iptat generation resistor 43 due to the voltage difference ΔVbe.

At this time, the voltage difference ΔVbe is represented by the difference between the base-emitter voltage V_{BE1} of the first transistor 41 and the base-emitter voltage V_{BE2} of the second transistor 42. Furthermore, when the Boltzmann multiplier is defined as k, the absolute temperature of the reference voltage generation circuit 1 is defined as T, the elementary charge is defined as q, the collector current is defined as Ic, and the saturation current is defined as Is, the voltage difference ΔVbe is expressed by Expression 1. For simplicity, the current amplification factor β is set to infinity. Regarding the subscripts attached to the collector current Ic and the saturation current Is, “1” indicates the first transistor 41 and “2” indicates the second transistor 41.

$$ΔV be = {V}_{BE 1} - {V}_{BE 2} = \frac{kT}{q} ln ( \frac{{Ic}_{1}}{{Is}_{1}} ) - \frac{kT}{q} ln ( \frac{{Ic}_{2}}{{Is}_{2}} ) = \frac{kT}{q} ( ln ( \frac{{Ic}_{1}}{{Ic}_{2}} \frac{{Is}_{2}}{{Is}_{1}} ) ) = \frac{kT}{q} ( ln ( \frac{{Ic}_{1}}{{Ic}_{2}} N ) ) \qquad ( Expression 1 )$$

Furthermore, when the resistance value of the temperature characteristic adjustment resistor 31 constituting the temperature characteristic adjustment circuit 30 is defined as R1 and the Zener voltage generated by the Zener diode 21 is defined as Vz, the reference voltage VREF is expressed by Expression 2. The resistance value of the Iptat generation resistor 43 is defined as R2. The PTAT current Iptat is a value obtained by dividing the voltage difference ΔVbe by the resistance value R2, and is expressed by Expression 3. The Zener voltage Vz generated by the Zener diode 21 and the PTAT current Iptat have temperature characteristics according to the absolute temperature T, and Vz(T) and Iptat(T) respectively indicate the Zener voltage Vz and the PTAT current Iptat at the absolute temperature T.

$$V REF = V z ( T ) - R 1 \cdot Iptat ( T ) \qquad ( Expression 2 )$$

$$Iptat = \frac{Δ V be}{R 2} \qquad ( Expression 3 )$$

In this way, the PTAT current Iptat is expressed as in Expression 3 and has a positive temperature characteristic. In addition, the Zener voltage Vz also has a positive temperature characteristic based on the characteristic of the Zener diode 21. As shown in Expression 2, the reference voltage VREF is a value obtained by subtracting the voltage drop at the temperature characteristic adjustment resistor 31, which also has a positive temperature characteristic, from the Zener voltage Vz(T), which has a positive temperature characteristic. Therefore, the temperature characteristic of the reference voltage VREF can be reduced, and by adjusting the resistance value R1 of the temperature characteristic adjustment resistor 31, it is possible to make the temperature characteristic of the reference voltage VREF to be even flat.

Therefore, the temperature characteristic of the reference voltage VREF can be reduced without requiring a configuration with a large number of elements such as an operational amplifier. Therefore, the influence of variations between elements can be reduced, and noise generated from the elements during circuit operation can be reduced, so that it is possible to improve the accuracy of the reference voltage VREF.

### Second Embodiment

A second embodiment of the present disclosure will be described. The configuration of the Iptat generation circuit 40 in the present embodiment is changed from that in the first embodiment, and the present embodiment is similar to the first embodiment in other aspects. Therefore, only portions different from those of the first embodiment will be described.

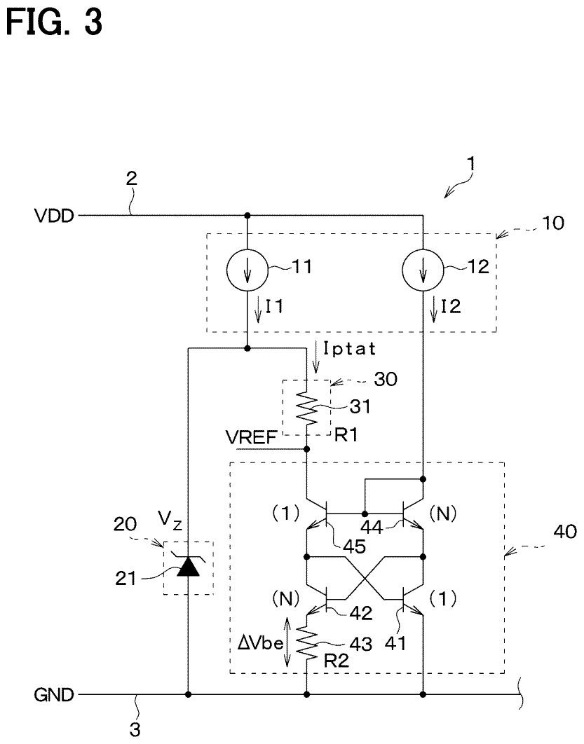

As shown in FIG. 3, the Iptat generation circuit 40 of this embodiment includes a group of transistors having a first transistor 41, a second transistor 42, a third transistor 44, and a fourth transistor 45, which are cross-coupled with each other. The PTAT current Iptat flows through the Iptat generation resistor 43 via the transistor group.

The third transistor 44 and the fourth transistor 45 are configured by NPN-type bipolar transistors. The current density is made different by, for example, making the element area of the third transistor 44 different from that of the fourth transistor 45, and the element area of the third transistor 44 is designed to be N times that of the fourth transistor 45. Here, N times is the same as N times the element area of the second transistor 42 relative to the element area of the first transistor 41. Specifically, the third transistor 44 and the fourth transistor 45 have their bases commonly connected to the second constant current source 12. The collector of the third transistor 44 is connected to the second constant current source 12, and the collector of the fourth transistor 45 is connected to the temperature characteristic adjustment circuit 30.

The first transistor 41 and the second transistor 42 are basically configured in the same manner as in the first embodiment, but the connections of the bases and collectors of the first transistor 41 and the second transistor 42 are different. That is, the first transistor 41 has a base connected to the emitter of the fourth transistor 45 and a collector connected to the emitter of the third transistor 44. The second transistor 42 has a base connected to the emitter of the third transistor 44 and a collector connected to the emitter of the fourth transistor 45.

Thus, in addition to the first transistor 41 and the second transistor 42, the third transistor 44 and the fourth transistor 45 are provided, which are cross-coupled to form a two-stage bipolar transistor configuration. With such a circuit configuration, the voltage difference ΔVbe between both ends of the Iptat generating resistor 43 becomes twice as large as in the first embodiment, but since the noise generated by the elements is uncorrelated, the noise becomes only 2½ times as large. Therefore, it is possible to substantially reduce noise.

### Modification of Second Embodiment

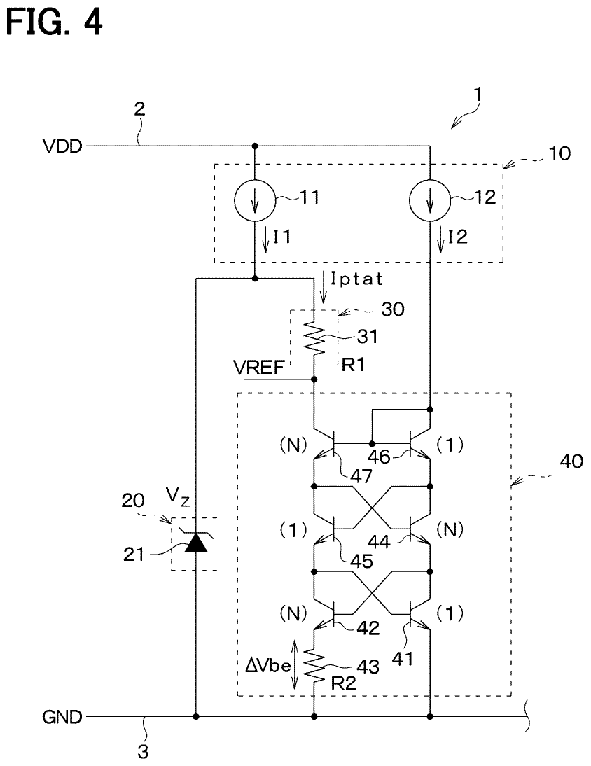

In the second embodiment, the bipolar transistors are cross-coupled to form two-stage bipolar transistor configuration. Alternatively, a further stage of bipolar transistors may be added to form three or more stages. For example, as shown in FIG. 4, a fifth transistor 46 and a sixth transistor 47 can be further provided to form a three-stage bipolar transistor configuration.

In this case as well, the fifth transistor 46 and the sixth transistor 47 are configured by NPN-type bipolar transistors. The current density is made different by, for example, making the element area of the fifth transistor 46 different from that of the sixth transistor 47, and the element area of the sixth transistor 47 is designed to be N times that of the fifth transistor 46. In addition, the bases of the fifth transistor 46 and the sixth transistor 47 are commonly connected to the second constant current source 12, the collector of the fifth transistor 46 is connected to the second constant current source 12, and the collector of the sixth transistor 47 is connected to the temperature characteristic adjustment circuit 30. As for the third transistor 44, the base is connected to the emitter of the sixth transistor 47, and the collector is connected to the emitter of the fifth transistor 46. Furthermore, the base of the fourth transistor 45 is connected to the emitter of the fifth transistor 46, and the collector is connected to the emitter of the sixth transistor 47.

In this way, the voltage difference ΔVbe between both ends of the Iptat generation resistor 43 can be increased to be proportional to the number of stages of bipolar transistors, that is, the integrated value of the differences in the base-emitter voltages of one transistor and the other transistor in each stage. Furthermore, since an increase in noise can be suppressed while increasing the voltage difference ΔVbe between both ends of the Iptat generation resistor 43, it is possible to achieve a more substantial noise reduction.

Although the case where the number of stages of bipolar transistors is three has been described here, the above-described effects can be obtained when a transistor group includes a plurality of pairs of transistors. That is, a pair of transistors arranged in sequence from the GND line 3 side is regarded as one set, and the following relationship is satisfied for each pair of transistors in each set. In each pair of transistors, the one of transistors through which the main collector-emitter current flows based on the current supply from the first constant current source 11 is defined as one transistor, and the other one of transistors through which the main collector-emitter current flows based on the current supply from the second constant current source 12 is defined as the other transistor. Furthermore, when the number of stages is defined as m (where m is a natural number equal to or greater than 2), the sets are referred to as the first set, the second set, . . . , the m-th set, in order from the GND line 3 side which is the lowest side.

That is, for odd-numbered sets, the element area of the other transistor is set to be N times the element area of the one transistor. Conversely, for even-numbered sets counting from the GND line 3 side, the element area of the one transistor is set to be N times the element area of the other transistor. In the first set, which is on the lowest side, the emitter of the one transistor is connected to the GND line 3, and the emitter of the other transistor is connected to an Iptat generation resistor 43. The base of the one transistor and the collector of the other transistor in the first set are connected to the emitter of the other transistor in the next second set. Furthermore, the collector of the one transistor and the base of the other transistor in the first set are connected to the emitter of the one transistor of the second set.

In addition, for the intermediate sets between the first set to the m-th set, the emitter of the one transistor is connected to the collector of the one transistor and the base of the other transistor in the previous set. Similarly, the emitter of the other transistor in the intermediate set is connected to the base of the one transistor and the collector of the other transistor in the previous set. In the m-th group, which is on the highest side, the collector and the base of the one transistor and the base of the other transistor are connected to the second constant current source 12, and the collector of the other transistor is connected to the temperature characteristic adjustment circuit 30. In this way, by configuring the Iptat generation circuit 40 by cross-coupling multiple stages of transistors, it is possible to achieve more substantial noise reduction.

### Third Embodiment

A third embodiment of the present disclosure will be described. This embodiment is different from the first and second embodiments in that it is provided with a function for adjusting the voltage value of the reference voltage VREF. Since the rest of the present embodiment is similar to the first and second embodiments, only the parts that differ from the first and second embodiments will be described.

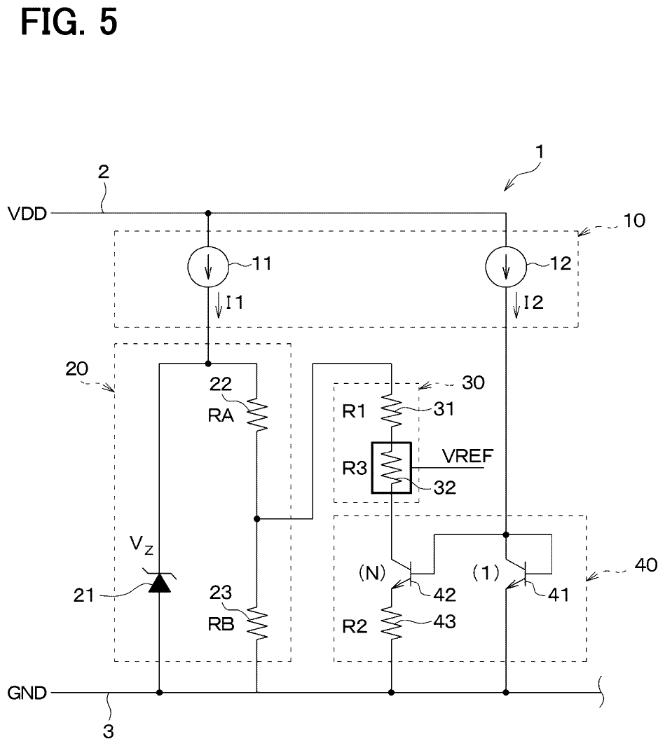

As shown in FIG. 5, the constant voltage generation circuit 20 of this embodiment includes a Zener diode 21, a first voltage division resistor 22 and a second voltage division resistor 23. A first voltage division resistor 22 and a second voltage division resistor 23 are connected in parallel to the Zener diode 21. The first voltage division resistor 22 and the second voltage division resistor 23 are connected in series between the first constant current source 11 and the GND line 3. The Zener voltage Vz is resistively divided by the first voltage division resistor 22 and the second voltage division resistor 23 to form a constant voltage lower than the Zener voltage Vz, thereby making it possible to lower the output voltage of the reference voltage VREF.

As in the first embodiment, when the Zener voltage Vz is used as a constant voltage and divided by the temperature characteristic adjustment resistor 31 and the Iptat generation resistor 43 to generate the reference voltage VREF, there is a possibility that the output voltage of the reference voltage VREF may become a desired voltage value, for example, 5 V or more. If the voltage exceeds the desired value, there is a possibility that the voltage may be disposed outside the operation range of subsequent circuits that operate based on the reference voltage VREF.

In contrast to this feature, if the first voltage division resistor 22 and the second voltage division resistor 23 are connected in parallel to the Zener diode 21, the constant voltage can be a voltage based on the Zener voltage Vz rather than the Zener voltage Vz itself, and can be a voltage obtained by resistively dividing the Zener voltage Vz. For example, if the resistance value of the first voltage division resistor 22 is defined as RA and the resistance value of the second voltage division resistor 23 is defined as RB, the constant voltage can be set to “Vz×RB/(RA+RB)”, and the reference voltage VREF can be generated based on this constant voltage. This makes it possible to prevent the output voltage of the reference voltage VREF from exceeding a desired voltage value, and allows the subsequent circuit that operates based on the reference voltage VREF to operate properly.

Furthermore, in this embodiment, the temperature characteristic adjustment circuit 30 includes a trimming resistor 32 in addition to the temperature characteristic adjustment resistor 31, making it possible to finely adjust the temperature characteristic of the output voltage of the reference voltage VREF.

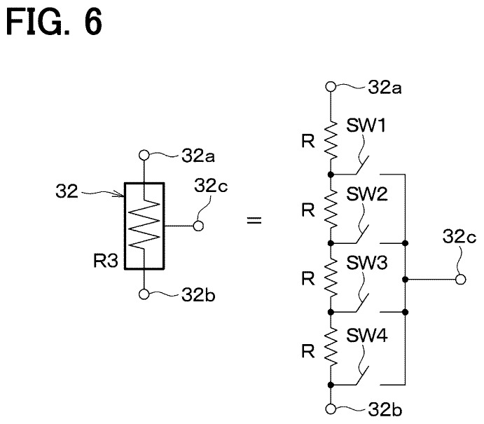

As shown in FIG. 6, if the high side of the two terminals of the trimming resistor 32 is designated as a first terminal 32a and the low side is designated as a second terminal 32b, a plurality of resistors R are connected in series between the first terminal 32a and the second terminal 32b. The low side of each resistor R is connected to an output terminal 32c via the switches SW1 to SW4, and the output voltage of the output terminal 32c is set to the reference voltage VREF. The switches SW1 to SW4 are configured, for example, by MOSFETs.

With this configuration, the resistance value of the trimming resistor 32 can be set by selecting which of the switches SW1 to SW4 to turn on. For example, it is assumed that the switches SW1 and SW4 are turned on. In this case, the PTAT current Iptat flows only through one of the resistors R that is closest to the first terminal 32a, and does not flow through the other resistors R because the PTAT current Iptat is bypassed via the switches SW1 and SW4. Therefore, the resistance value R3 of the trimming resistor 32 is set to the resistance value of the one resistor R. In this manner, by providing the trimming resistor 32 in the temperature characteristic adjustment circuit 30, it becomes possible to finely adjust the temperature characteristic of the reference voltage VREF. Specifically, in the reference voltage generation circuit 1 of the present embodiment, the reference voltage VREF is expressed as in Expression 4.

$$V REF = \frac{RA}{RA + RB} V z ( T ) - ( R 1 + R 3 ) Iptat ( T ) \qquad ( Expression 4 )$$

Therefore, by adjusting the resistance value R3 of the trimming resistor 32 by controlling the switches SW1 to SW4, the temperature characteristic of the reference voltage VREF can be finely adjusted, and the temperature characteristic of the output voltage can be set to any desired value.

### Fourth Embodiment

A fourth embodiment of the present disclosure will be described. The configuration of the Iptat generation circuit 40 in the present embodiment is changed from that in the first to third embodiments, and the present embodiment is similar to the first to third embodiments in other aspects. Therefore, only portions different from those of the first to third embodiments will be described. Although the circuit configuration of this embodiment is applied to the circuit configuration of the first embodiment, it can also be applied to the circuit configurations of the second and third embodiments.

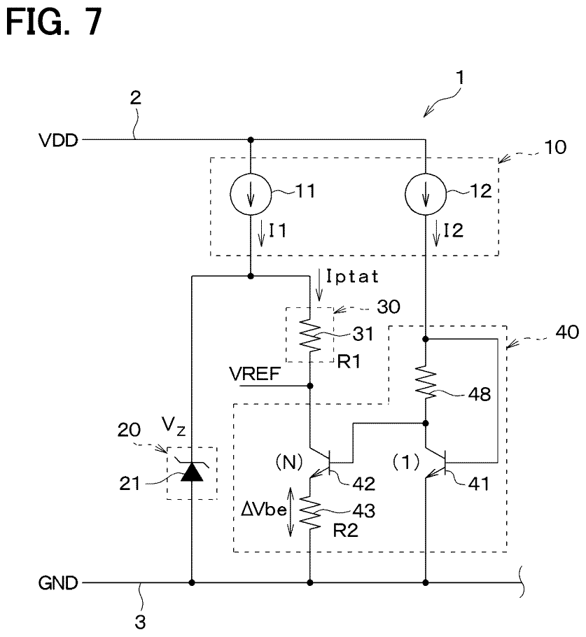

As shown in FIG. 7, the reference voltage generation circuit 1 of this embodiment is provided with a fluctuation suppression resistor 48 between the second constant current source 12 and the collector of the first transistor 41 in the Iptat generation circuit 40, that is, between the base and the collector of the first transistor 41. In other words, the base of the first transistor 41 is connected to the second constant current source 12, while the collector is connected to the second constant current source 12 via the fluctuation suppression resistor 48.

In this manner, by adding the fluctuation suppression resistor 48, the fluctuation of the collector voltage in response to the fluctuation of the base voltage of the first transistor 41 is suppressed. This makes it possible to reduce noise caused by fluctuations in the collector voltage.

### Fifth Embodiment

A fifth embodiment of the present disclosure will be described. The configuration of the constant current source 10 in the present embodiment is changed from that in the first to fourth embodiments, and the present embodiment is similar to the first to fourth embodiments in other aspects. Therefore, only portions different from those of the first to fourth embodiments will be described. Although the circuit configuration of this embodiment is applied to the circuit configuration of the first embodiment, it can also be applied to the circuit configurations of the second to fourth embodiments.

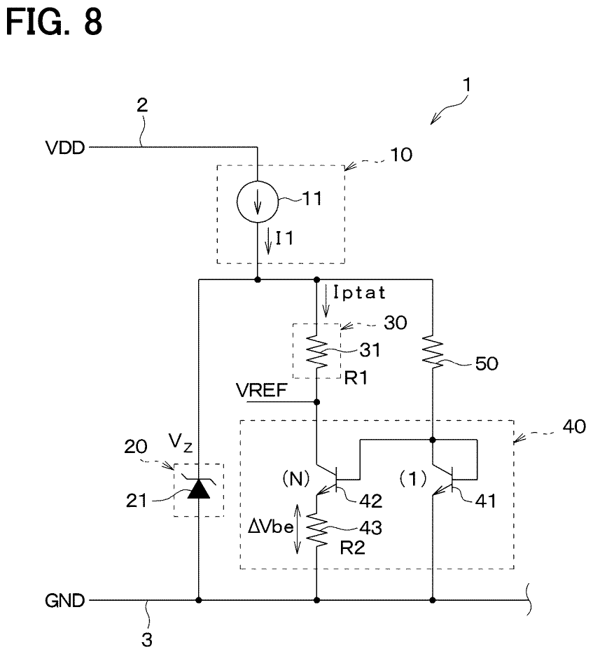

As shown in FIG. 8, in the reference voltage generation circuit 1 of this embodiment, the constant current source 10 includes only one first constant current source 11. One constant current source 10 generates a first constant current I1 which provides a current to a constant voltage generation circuit 20 and a PTAT current Iptat to a temperature characteristic adjustment circuit 30, a second transistor 42, and an Iptat generation resistor 43, and a second constant current I2 which is supplied to a first transistor 41. A current adjustment resistor 50 is provided between the constant current source 10 and the collector of the first transistor 41, and the second constant current I2 supplied to the first transistor 41 can be adjusted to an arbitrary current by the current adjustment resistor 50.

In this manner, the reference voltage generation circuit 1 can be configured using only one constant current source 10. In this case, the number of constant current sources 10 is reduced to one, thereby reducing the number of noise sources, making it possible to further reduce noise. Furthermore, the constant voltage generation circuit 20 forms a constant voltage based on the Zener voltage Vz generated by the Zener diode 21, and this constant voltage is applied to the current adjustment resistor 50, the first transistor 41, and the like. Therefore, due to the rectifying effect of the Zener diode 21, the noise of not only the second transistor 42 but also the first transistor 41 is reduced, making it possible to further reduce noise.

### Other Embodiments

Although the present disclosure has been described on the basis of the embodiments described above, the present disclosure is not limited to the embodiments but also includes various modifications and modifications within an equivalent range. In addition, while the various combinations and configurations, which are preferred, other combinations and configurations, including more, less or only a single element, are also within the spirit and scope of the present disclosure.

For example, the numbers of various resistors and the number of Zener diodes 21 shown in the first to fifth embodiments can be changed as appropriate according to the design of the circuit to which the reference voltage generation circuit 1 is applied. When the number of resistors R included in the trimming resistor 32 described in the third embodiment is changed, the number of switches SW1 to SW4 may be increased accordingly. In addition, the multiple resistors R may have the same resistance value, but they may have different resistance values, for example, the resistance value of one resistor may be set to two, four, or eight times that of the other resistors, thereby making it possible to broaden the range of trimmable resistance values.

In addition, in the above third embodiment, the constant voltage generation circuit 20 is configured to form a constant voltage by resistance voltage division using the first voltage division resistor 22 and the second voltage division resistor 23, and is configured to include a trimming resistor 32 to finely adjust the resistance value of the temperature characteristic adjustment circuit 30. A configuration in which only one of these is provided may also be used.

In addition, in each of the above embodiments, the first constant current source 11 and the second constant current source 12 share the same power supply voltage VDD as their power supply. Alternatively, different power supply voltages may be used.

Furthermore, while it has been shown that the third to fifth embodiments are applicable to each of the embodiments including the first and second embodiments, they can of course also be applied to a modified example of the second embodiment.

### (Various Features of Present Disclosure)

The present disclosure described above can be understood from the following features, for example.

### (Feature 1)

A reference voltage generation circuit that outputs a reference voltage, includes: a constant current source that generates a constant current; a constant voltage generation circuit having a Zener diode to which a current is supplied from the constant current source, and generating a constant voltage based on a Zener voltage generated by the Zener diode; a current generation circuit that generates a PTAT current having a positive temperature characteristic with respect to absolute temperature based on the constant voltage without including an operational amplifier; and a temperature characteristic adjustment circuit including a temperature characteristic adjustment resistor through which the PTAT current generated by the current generation circuit flows. A voltage acquired by subtracting a voltage drop in the temperature characteristic adjustment circuit when the PTAT current flows from the constant voltage is output as the reference voltage.

### (Feature 2)

In the reference voltage generation circuit according to feature 1, the current generation circuit includes one transistor, an other transistor having a current density different from that of the one transistor, and a current adjustment resistor through which the PTAT current flows. A current is supplied from the constant current source between a collector and an emitter of the one transistor. A collector of the other transistor is connected to the temperature characteristic adjustment circuit, an emitter of the other transistor is connected to the current adjustment resistor, and a base of the other transistor is connected to the collector of the one transistor. The PTAT current is caused to flow through the temperature characteristic adjustment circuit, between the collector and the emitter of the other transistor, and through the current adjustment resistor based on the current supplied from the constant current source. A differential voltage between a base-emitter voltage of the one transistor and a base-emitter voltage of the other transistor is generated as a voltage difference between both ends of the current adjustment resistor.

### (Feature 3)

In the reference voltage generation circuit according to feature 1, the current generation circuit includes a transistor group in which a plurality of sets of transistors are cross-coupled and connected each other and a current adjustment resistor through which the PTAT current flows. Each set of transistors includes one transistor and an other transistor having a current density different from that of the one transistor. A current is supplied from the constant current source between a collector and an emitter of the one transistor included in each set of transistors in the transistor group. A collector of the other transistor included in the transistor group and disposed on a highest side is connected to the temperature characteristic adjustment circuit, and an emitter of the other transistor included in the transistor group and disposed on a lowest side is connected to the current adjustment resistor. The PTAT current is caused to flow through the temperature characteristic adjustment circuit, between the collector and the emitter of the other transistor in each set of transistors in the transistor group, and through the current adjustment resistor based on the current supplied from the constant current source. A voltage obtained by integrating a differential voltage between a base-emitter voltage of the one transistor and a base-emitter voltage of the other transistor in each set of transistors in the transistor group is generated as a voltage difference between both ends of the current adjustment resistor.

### (Feature 4)

The reference voltage generation circuit according to feature 2 or 3, further includes: a fluctuation suppression resistor provided between the base and the collector of the one transistor for suppressing a fluctuation in a collector voltage in response to a fluctuation in a base voltage of the one transistor.

### (Feature 5)

In the reference voltage generation circuit according to any one of features 2 to 4, the constant current source includes a first constant current source and a second constant current source. The constant voltage is generated by supplying a current based on a first constant current generated by the first constant current source to the Zener diode. The PTAT current is generated by supplying the current based on the first constant current to the temperature characteristic adjustment circuit, between the collector and the emitter of the other transistor, and to the current adjustment resistor. A second constant current smaller than the first constant current generated by the second constant current source is supplied between the collector and the emitter of the one transistor.

### (Feature 6)

In the reference voltage generation circuit according to any one of features 2 to 4, the constant current source includes only one constant current source element. The reference voltage generation circuit further includes a current adjustment resistor provided between the constant current source and the one transistor. The constant voltage is generated by supplying a current based on a constant current generated by the constant current source to the Zener diode. The PTAT current is generated by supplying the current based on the constant current to the temperature characteristic adjustment circuit, between the collector and the emitter of the other transistor, and to the current adjustment resistor. The current based on the constant current generated by the constant current source is supplied between the collector and the emitter of the other transistor via the current adjustment resistor.

### (Feature 7)

In the reference voltage generation circuit according to any one of features 1 to 6, the temperature characteristic adjustment circuit includes a trimming resistor in addition to a temperature characteristic adjustment resistor. A voltage drop in the temperature characteristic adjustment circuit when the PTAT current flows is a voltage drop in the temperature characteristic adjustment circuit when the PTAT current flows through the temperature characteristic adjustment resistor and the trimming resistor. A voltage obtained by subtracting the voltage drop from the constant voltage is output as the reference voltage.

### (Feature 8)

In the reference voltage generation circuit according to any one of features 1 to 6, the constant voltage generation circuit has a first voltage division resistor and a second voltage division resistor connected in parallel to the Zener diode. A voltage divided by the first voltage division resistor and the second voltage division resistor is formed as the constant voltage.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A reference voltage generation circuit that outputs a reference voltage, comprising:
a constant current source that generates a constant current;
a constant voltage generation circuit having a Zener diode to which the constant current is supplied from the constant current source, and generating a constant voltage based on a Zener voltage generated by the Zener diode;
a current generation circuit that generates a PTAT current having a positive temperature characteristic with respect to absolute temperature based on the constant voltage without including an operational amplifier; and
a temperature characteristic adjustment circuit including a temperature characteristic adjustment resistor through which the PTAT current generated by the current generation circuit flows, wherein:
a voltage acquired by subtracting a voltage drop in the temperature characteristic adjustment circuit when the PTAT current flows from the constant voltage is output as the reference voltage.

2. The reference voltage generation circuit according to claim 1, wherein:
the current generation circuit includes one transistor, an other transistor having a current density different from that of the one transistor, and a current adjustment resistor through which the PTAT current flows;
the constant current is supplied from the constant current source between a collector and an emitter of the one transistor;
a collector of the other transistor is connected to the temperature characteristic adjustment circuit, an emitter of the other transistor is connected to the current adjustment resistor, and a base of the other transistor is connected to the collector of the one transistor;
the PTAT current is caused to flow through the temperature characteristic adjustment circuit, between the collector and the emitter of the other transistor, and through the current adjustment resistor based on the constant current supplied from the constant current source; and
a differential voltage between a base-emitter voltage of the one transistor and a base-emitter voltage of the other transistor is generated as a voltage difference between both ends of the current adjustment resistor.

3. In the reference voltage generation circuit according to claim 1, wherein:
the current generation circuit includes a transistor group in which a plurality of sets of transistors are cross-coupled and connected each other and a current adjustment resistor through which the PTAT current flows;
each set of transistors includes one transistor and an other transistor having a current density different from that of the one transistor;
the constant current is supplied from the constant current source between a collector and an emitter of the one transistor included in each set of transistors in the transistor group;
a collector of the other transistor included in the transistor group and disposed on a highest side is connected to the temperature characteristic adjustment circuit, and an emitter of the other transistor included in the transistor group and disposed on a lowest side is connected to the current adjustment resistor;
the PTAT current is caused to flow through the temperature characteristic adjustment circuit, between the collector and the emitter of the other transistor in each set of transistors in the transistor group, and through the current adjustment resistor based on the constant current supplied from the constant current source; and
a voltage obtained by integrating a differential voltage between a base-emitter voltage of the one transistor and a base-emitter voltage of the other transistor in each set of transistors in the transistor group is generated as a voltage difference between both ends of the current adjustment resistor.

4. The reference voltage generation circuit according to claim 2, further comprising:
a fluctuation suppression resistor provided between the base and the collector of the one transistor for suppressing a fluctuation in a collector voltage in response to a fluctuation in a base voltage of the one transistor.

5. The reference voltage generation circuit according to claim 2, wherein:
the constant current source includes a first constant current source and a second constant current source;
the constant voltage is generated by supplying a current based on a first constant current generated by the first constant current source to the Zener diode;
the PTAT current is generated by supplying the current based on the first constant current to the temperature characteristic adjustment circuit, between the collector and the emitter of the other transistor, and to the current adjustment resistor; and
a second constant current smaller than the first constant current generated by the second constant current source is supplied between the collector and the emitter of the one transistor.

6. The reference voltage generation circuit according to claim 2, wherein:
the constant current source includes only one constant current source element;
the reference voltage generation circuit further comprising:
a current adjustment resistor provided between the constant current source and the one transistor, wherein:
the constant voltage is generated by supplying a current based on the constant current generated by the constant current source to the Zener diode;
the PTAT current is generated by supplying the current based on the constant current to the temperature characteristic adjustment circuit, between the collector and the emitter of the other transistor, and to the current adjustment resistor; and
the current based on the constant current generated by the constant current source is supplied between the collector and the emitter of the other transistor via the current adjustment resistor.

7. The reference voltage generation circuit according to claim 1, wherein:
the temperature characteristic adjustment circuit includes a trimming resistor in addition to a temperature characteristic adjustment resistor;
a voltage drop in the temperature characteristic adjustment circuit when the PTAT current flows is a voltage drop in the temperature characteristic adjustment circuit when the PTAT current flows through the temperature characteristic adjustment resistor and the trimming resistor; and
a voltage obtained by subtracting the voltage drop from the constant voltage is output as the reference voltage.

8. The reference voltage generation circuit according to claim 1, wherein:
the constant voltage generation circuit has a first voltage division resistor and a second voltage division resistor connected in parallel to the Zener diode; and
a voltage divided by the first voltage division resistor and the second voltage division resistor is formed as the constant voltage.
